(19) United States
(12) Patent Application Publication
(10) Pub. No.: US 2016/0378209 A1
(43) Pub. Date: Dec. 29, 2016

(54) SINGLE STYLUS FOR USE WITH MULTIPLE INKING TECHNOLOGIES

(71) Applicant: Intel Corporation, Santa Clara, CA (US)

(72) Inventors: Hong W. Wong, Portland, OR (US); Zhiming Jim Zhuang, Sammamish, WA (US); Shwetank Kumar, San Francisco, CA (US); Rocendo Bracamontes, Sherwood, OR (US); Arvind Kumar, Beaverton, OR (US); Murali Veeramoney, Portland, OR (US)

(73) Assignee: Intel Corporation, Santa Clara, CA (US)

(21) Appl. No.: 14/752,925

(22) Filed: Jun. 27, 2015

(51) Int. Cl. G06F 3/0354; G06F 3/044; G06F 3/046; G06F 3/038

(52) U.S. Cl. CPC G06F 3/03545; G06F 3/0383; G06F 3/044; G06F 3/046; G06F 2203/0381; G06F 2203/04106

(57) ABSTRACT

Particular embodiments described herein provide for a stylus that includes a body, a plurality of conductive traces, a resonance circuit, and a tip, wherein the tip can be used to interact with both an electromagnetic resonance touchscreen and a capacitive touchscreen. The conductive traces can be spaced such that the conductive traces do not substantially block a resonance frequency of the resonance circuit.

### TECHNICAL FIELD

Embodiments described herein generally relate to the field of styluses and, more particularly, to a single stylus for use with multiple inking technologies.

### BACKGROUND

End users have more electronic device choices than ever before. A number of prominent technological trends are currently afoot (e.g., more computing devices, more detachable displays, etc.), and these trends are changing the electronic device landscape. One of the technological trends is the use of a stylus. The term stylus often refers to an input tool used with touchscreen-enabled devices to navigate interface elements, send messages, write, draw, or mark on the display, etc. However, there is currently not one unified type of input technology. Hence, there is a challenge in providing a stylus that can interact with different types of input technology.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified cut-away diagram illustrating an embodiment of a single stylus for use with multiple inking technologies, in accordance with one embodiment of the present disclosure;

FIG. 1B is a simplified cut-away diagram illustrating an embodiment of a single stylus for use with multiple inking technologies, in accordance with one embodiment of the present disclosure;

FIG. 2 is a simplified plan cut-away diagram illustrating an embodiment of a single stylus for use with multiple inking technologies, in accordance with one embodiment of the present disclosure;

FIG. 3 is a simplified schematic cut-away diagram illustrating an embodiment of a portion of a single stylus for use with multiple inking technologies, in accordance with one embodiment of the present disclosure;

FIG. 4 is a simplified schematic cut-away diagram illustrating an embodiment of a portion of a single stylus for use with multiple inking technologies, in accordance with one embodiment of the present disclosure;

FIG. 5 is a block diagram illustrating an example computing system that is arranged in a point-to-point configuration in accordance with an embodiment;

FIG. 6 is a simplified block diagram associated with an example ARM ecosystem system on chip (SOC) of the present disclosure; and

FIG. 7 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

The following detailed description sets forth example embodiments of apparatuses, methods, and systems relating to a single stylus for use with multiple inking technologies. Features such as structure(s), function(s), and/or characteristic(s), for example, are described with reference to one embodiment as a matter of convenience; various embodiments may be implemented with any suitable one or more of the described features.

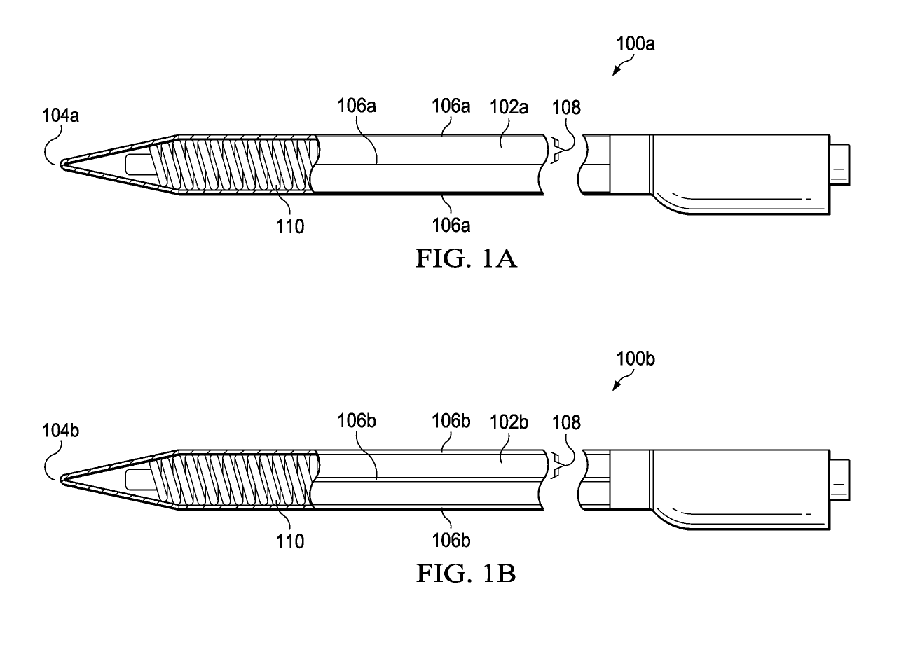

FIG. 1A is a simplified cut-away diagram illustrating an embodiment of a stylus 100a, in accordance with one embodiment of the present disclosure. Stylus 100a can be a single stylus for use with multiple inking technologies and may include a body 102a, a writing tip 104a, a plurality of conductive traces 106a, and a resonance circuit 110. A spacing 108 between plurality of conductive traces 106a can be configured such that plurality of conductive traces 106a do not block a resonance frequency from resonance circuit 110. Plurality of conductive traces 106a may be in contact with writing tip 104a of stylus 100a and embedded on or in body 102a.

Turning to FIG. 1B, FIG. 1B is a simplified cut-away diagram illustrating an embodiment of a stylus 100b, in accordance with one embodiment of the present disclosure. Stylus 100b can be a single stylus for use with multiple inking technologies and may include a body 102b, a writing tip 104b, a plurality of conductive traces 106b, and resonance circuit 110. Spacing 108 between plurality of conductive traces 106b can be configured such that plurality of conductive traces 106b do not block a resonance frequency from resonance circuit 110. Writing tip 104b of stylus 100b may include conductive rubber or plastic material and plurality of conductive traces 106b may include conductive rubber or plastic that is molded into body 102b of stylus 100b.

For purposes of illustrating certain example features of stylus 100a and 100b, the following foundational information may be viewed as a basis from which the present disclosure may be properly explained. A current technological trend is the use of touchscreens. Touchscreens are common in devices such as mobile devices, personal digital assistants, smartphones, tablets, desktop computers, laptop computers, game consoles, GPS navigation devices, mobile phones, or other similar devices. Touchscreens are also found in devices in the medical field and heavy industry, as well as for automated teller machines (ATMs), and kiosks such as museum displays or room automation, where keyboard and mouse systems do not allow a suitably intuitive, rapid, or accurate interaction by the user with the display's content.

There are a variety of touchscreen technologies that have different methods of sensing touch. For example, a resistive touchscreen panel includes several layers. The most important of which are two thin, transparent electrically-resistive layers separated by a thin space. These layers face each other with a thin gap between a top screen and a resistive layer. The top screen (the screen that is touched) has a coating on the underside surface of the screen. Just beneath the coating is a similar resistive layer on top of a substrate. One layer has conductive connections along its sides while the other layer has conductive connections along the top and bottom. When the touchscreen is touched, voltage is applied to one layer and sensed by the other. When an object such as a stylus tip presses down onto the outer surface, the two layers touch to become connected at the point of the touch. The panel then behaves as a pair of voltage dividers, one axis at a time. By rapidly switching between each layer, the position of pressure on the screen can be read and interpreted as input.

A capacitive touchscreen panel can include an insulator, such as glass, coated with a transparent conductor, such as indium tin oxide (ITO). A stylus can act as an electrical conductor and when the stylus touches the surface of the screen, a distortion of the screen's electrostatic field occurs and can be measured as a change in capacitance. Different technologies may be used to determine the location of the touch and the location can be sent to a controller associated with the touchscreen for processing.

An electromagnetic resonance (EMR) touchscreen uses EMR technology to capture the location of touch on the touchscreen. In EMR, the device with the EMR touchscreen can provide power to the stylus through resonant inductive coupling. As a result, no battery or cord is required for the stylus.

Stylus or pen computing refers to a computer user-interface using a stylus and touchscreen device, rather than a peripheral device such as a keyboard, joystick, or a mouse. The term stylus often refers to an input tool used with touchscreen-enabled devices to navigate interface elements, send messages, write, draw, or mark on the display, etc. The stylus is used as a pointing or touch device, such as to replace a mouse, and can be used to touch, press, or drag on simulated objects directly. While a mouse is a relative pointing device (one uses the mouse to “push the cursor around” on a screen), the stylus is an absolute pointing device (one places the stylus where the cursor is to appear). The stylus can be used to replace a keyboard, or both a mouse and a keyboard, by using the stylus in a pointing mode where the stylus is used as a pointing device and a handwriting recognition mode, where the strokes made with the stylus are analyzed as electronic ink, by a touchscreen module which recognizes the shapes of the strokes or marks as handwritten characters. The characters are then input as text, as if from a keyboard. Different systems can switch between the modes (pointing vs. handwriting recognition) using different means. Gesture recognition is the technique of recognizing certain special shapes not as handwriting input, but as an indicator of a special command. For example, a “pig-tail” shape (used often as a proofreader's mark) could indicate a “delete” operation. Depending on the implementation, what is deleted might be the object or text where the mark was made, or the stylus can be used as a pointing device to select what it is that should be deleted.

There are a variety of touchscreen technologies that have different methods of sensing touch, however, there is currently not one unified type of input technology. For example, different displays could use different technologies such as a capacitive screen or an electro-magnetic resonance (EMR) digitizer to capture the handwriting on the screens/displays. What is needed is a stylus that can be used on multiple displays using different technologies.

A single stylus for use with multiple inking technologies as outlined herein can resolve these issues (and others). Particular embodiments described herein provide for a stylus that is configured to be used on different writing surface or displays using different technologies. The stylus can operate as an EMR type stylus that can generate an equivalent amount of capacitance as a “passive” stylus while at the same time, can function in an EMR environment. Further, the stylus can have the same tip or contact point and the tip can be used on each of the different surfaces so there is no need to rotate the stylus or change the tip when writing to different displays. For example, the stylus can be configured to work on capacitive touch/inking/stylus technology on E-ink, LCD, OLED, cholesteric liquid crystal display (ChLCD), EMR digitizer technology on E-ink, LCD, OLED, ChLCD, or a mix of capacitive and EMR technologies inputs on E-ink, LCD, OLED, ChLCD. In addition, the stylus does not require any batteries to operate and the tips can be replaceable and customizable to suit a user's preference and to enhance the writing experience.

In a specific example, conductive traces (e.g., conductive traces 106a and 106b) can be added to the body (e.g., body 102a and 102b) of the stylus which can be configured to enhance the capacitance of the stylus when the hand of a user is holding (touching the conductive traces on) the stylus. The traces can be of many forms and shapes, such as a fish net design. The conductive traces may be in contact with the tip of the pen and embedded on or in the surface of the pen. The spacing (e.g., spacing 108) between the traces can be such that the traces will not block the resonance frequency of the EMR stylus. For example, the spacing between the tracings may not block a resonance frequency of 451 KHz used in some types of styluses. The stylus can have a resonance circuitry (e.g., resonance circuit 110) that includes a capacitor and an inductor tuned to operate at the resonance frequency of a sensor coil. A ground of the resonance circuitry can be connected to the conductive traces of the stylus to effect the generation of capacitance when a user is holding the stylus.

In another specific example, the tip of the stylus may include conductive rubber or plastic material and the conductive traces may be made of conductive rubber or plastic that is molded into the housing of the stylus. The spacing (e.g., spacing 108) between the traces can be such that the traces will not block the resonance frequency of the he EMR stylus. For example, the spacing between the tracings may not block the resonance frequency of 451 KHz used in some types of styluses. The stylus can have a resonance circuitry that includes a capacitor and an inductor, tuned to operate at the resonance frequency of a sensor coil. A ground of the resonance circuitry can be connected to the conductive traces of the stylus to effect the generation of capacitance when a user holding the stylus.

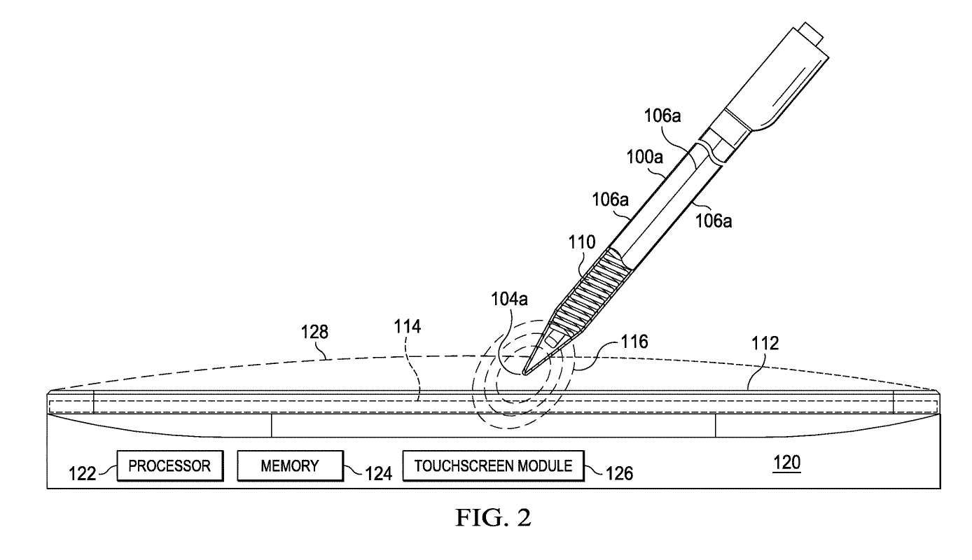

Turning to FIG. 2, FIG. 2 is a simplified block diagram of stylus 100a in accordance with one embodiment of the present disclosure. As illustrated in FIG. 2, stylus 100a can be used on display 112 of an electronic device 120. Electronic device 120 can include a processor 122, memory 124, and a touchscreen module 126. Touchscreen module 126 can be configured to receive input when stylus 100a touches display 112, interpret the input, and provide a response to the input.

Display 112 can be configured as a touchscreen and respond to input from stylus 100a. A touchscreen is an input device normally layered on the top of a visual display of an electronic device (e.g., electronic device 120). A user can give input to or control the electronic device through simple or multi-touch gestures by touching the screen with stylus 100a. The touchscreen enables the user to interact directly with what is displayed, rather than using a mouse, touchpad, or any other intermediate device. In an example, a sensor unit 114 may be under display 112. Touch input from stylus 100a on display 112 can produce a touch input signal that is communicated to touchscreen module 124 for an appropriate system response. If the display 112 is an EMR touchscreen, then electronic device 120 can produce a magnetic field 128 around display 112. Using resonance circuit 110 on stylus 100a a resonance frequency 116 can be produced that can interact with magnetic field 128 and allow sensor unit 114 to determine the location of tip 104a on stylus 100a for touch input.

If display 112 is a capacitive touchscreen, stylus 100a can act as an electrical conductor using plurality of conductive traces 106a. When the stylus touches the surface of the display 112, a distortion of the screen's electrostatic field can occur and can be measured as a change in capacitance. Spacing 108 between plurality of conductive traces 106a can be configured such that plurality of conductive traces 106b do not block a resonance frequency of stylus 100b and thus allow stylus 100a to be used on both an EMR touchscreen and a capacitive touchscreen.

In one or more embodiments, electronic device 120 is a tablet computer. In still other embodiments, electronic device 120 may be any suitable electronic device having a touchscreen display such as a mobile device, a tablet device (e.g., i-Pad™), Phablet™, a personal digital assistant (PDA), a smartphone, an audio system, a movie player of any type, etc.

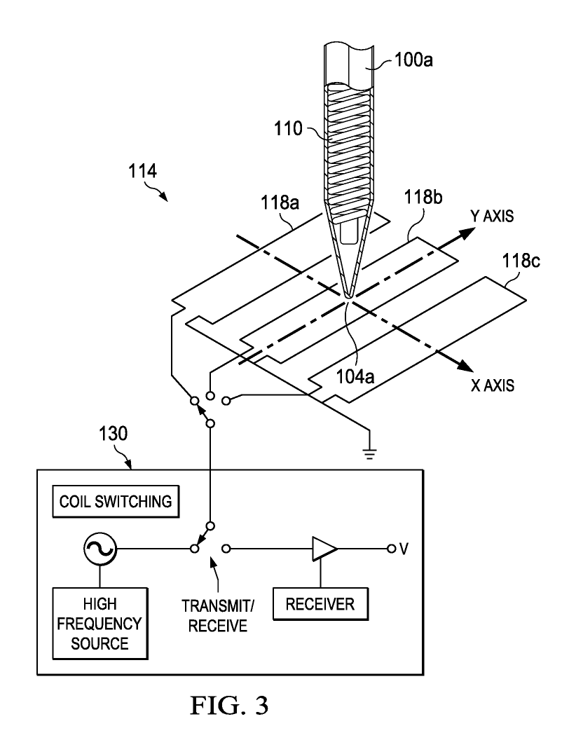

Turning to FIG. 3, FIG. 3 is a simplified block diagram of stylus 100a interacting with sensor unit 114 in accordance with one embodiment of the present disclosure. Sensor unit 114 can include a plurality of antenna coils 118a-118c. Sensor unit 114 can also include a stylus detection circuit 130 to detect input from stylus 100a. In an example, stylus detection circuit 130 is located in touchscreen module 126 shown in FIG. 2. Initially resonance circuit 110 is a receiver coil (similar to RFID/NFC). Resonance circuit 110 can harvest the energy from antenna coils 118a-118c and then transmit the energy to antenna coils 118a-118c. Using stylus detection circuit 130, antenna coils 118a-118c can also switch from (initial) transmit mode to a receive mode and receive information from stylus 100a.

Multiple antenna coils (e.g., antenna coils 118a-118c) in a grid array can be located under an electronic device's touchscreen's surface and a magnetic reflector may be located behind the grid array. In send mode, the electronic device generates a close-coupled electromagnetic field (also known as a B-field) at a frequency of 531 kHz. This close-coupled field stimulates oscillation in the coil/capacitor (LC) circuit of stylus 100a when brought into range of the B-field. Any excess resonant electromagnetic energy is reflected back to the tablet. In receive mode, the energy of the resonant circuit's oscillations in stylus 100a is detected by antenna coils 118a-118c. This information is analyzed by touchscreen module 126 to determine the position of stylus 100a. The analysis may be by interpolation and Fourier analysis of the signal intensity from stylus 100a can be performed. In addition, stylus 100a can communicate information such as writing tip 104a pressure, side-switch status, tip vs. eraser orientation, and the ID number of stylus 100a (to differentiate between different pens, etc.). For example, applying more or less pressure to writing tip 104a of stylus 100a can change the value of timing circuit capacitor in stylus 100a. This signal change can be communicated in an analog or digital method. An analog implementation would modulate the phase angle of the resonant frequency and a digital method can be communicated to a modulator which distributes the information digitally to electronic device 120.

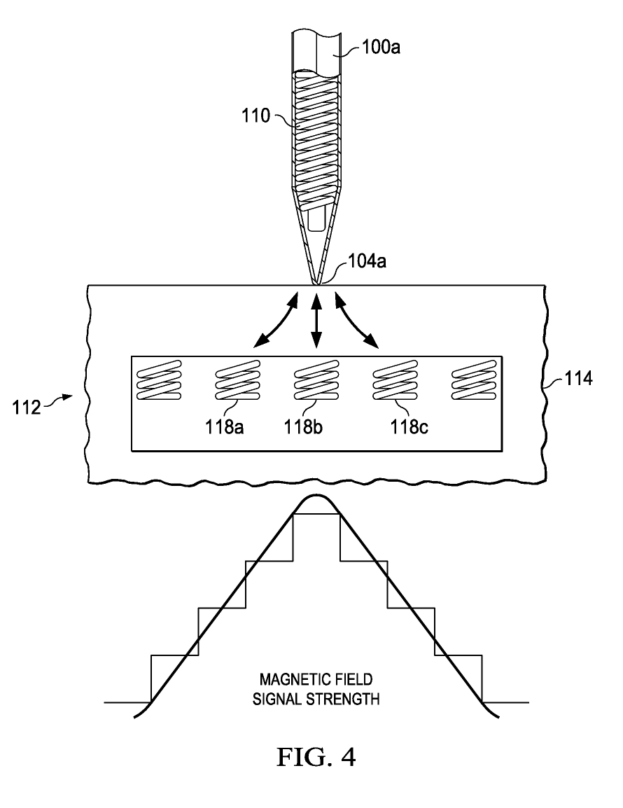

Turning to FIG. 4, FIG. 4 is a simplified block diagram of stylus 100a interacting with sensor unit 114 in accordance with one embodiment of the present disclosure. When writing tip 104a comes into contact with display 112, the energy of the resonant circuit's oscillations generated by resonance circuit 110 in stylus 100a is detected by antenna coils 118a-118c. This information is analyzed by touchscreen module 126 to determine the position of stylus 100a.

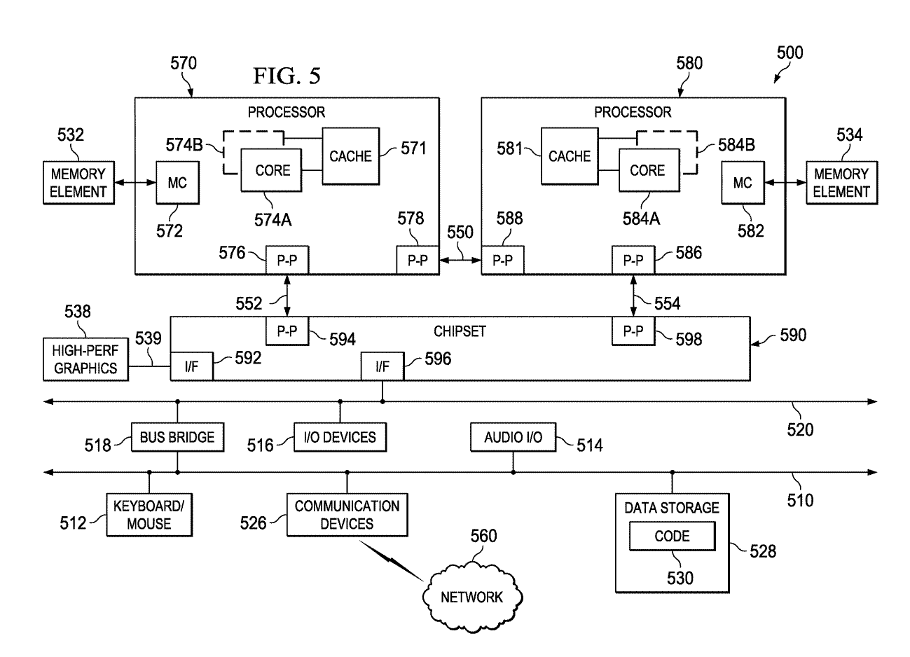

FIG. 5 illustrates a computing system 500 that is arranged in a point-to-point (PtP) configuration according to an embodiment. In particular, FIG. 5 shows a system where processors, memory, and input/output devices are interconnected by a number of point-to-point interfaces. Generally, electronic device 120 may be configured in the same or similar manner as computing system 500.

As illustrated in FIG. 5, system 500 may include several processors, of which only two, processors 570 and 580, are shown for clarity. While two processors 570 and 580 are shown, it is to be understood that an embodiment of system 500 may also include only one such processor. Processors 570 and 580 may each include a set of cores (i.e., processor cores 574A and 574B and processor cores 584A and 584B) to execute multiple threads of a program. The cores may be configured to execute instruction code in a manner similar to that discussed above with reference to FIGS. 1-4. Each processor 570, 580 may include at least one shared cache 571, 581. Shared caches 571, 581 may store data (e.g., instructions) that are utilized by one or more components of processors 570, 580, such as processor cores 574 and 584.

Processors 570 and 580 may also each include integrated memory controller logic (MC) 572 and 582 to communicate with memory elements 532 and 534. Memory elements 532 and/or 534 may store various data used by processors 570 and 580. In alternative embodiments, memory controller logic 572 and 582 may be discrete logic separate from processors 570 and 580.

Processors 570 and 580 may be any type of processor and may exchange data via a point-to-point (PtP) interface 550 using point-to-point interface circuits 578 and 588, respectively. Processors 570 and 580 may each exchange data with a chipset 590 via individual point-to-point interfaces 552 and 554 using point-to-point interface circuits 576, 586, 594, and 598. Chipset 590 may also exchange data with a high-performance graphics circuit 538 via a high-performance graphics interface 539, using an interface circuit 592, which could be a PtP interface circuit. In alternative embodiments, any or all of the PtP links illustrated in FIG. 5 could be implemented as a multi-drop bus rather than a PtP link.

Chipset 590 may be in communication with a bus 520 via an interface circuit 596. Bus 520 may have one or more devices that communicate over it, such as a bus bridge 518 and I/O devices 516. Via a bus 510, bus bridge 518 may be in communication with other devices such as a keyboard/mouse 512 (or other input devices such as a touch screen, trackball, etc.), communication devices 526 (such as modems, network interface devices, or other types of communication devices that may communicate through a computer network 560), audio I/O devices 514, and/or a data storage device 528. Data storage device 528 may store code 530, which may be executed by processors 570 and/or 580. In alternative embodiments, any portions of the bus architectures could be implemented with one or more PtP links.

The computer system depicted in FIG. 5 is a schematic illustration of an embodiment of a computing system that may be utilized to implement various embodiments discussed herein. It will be appreciated that various components of the system depicted in FIG. 5 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

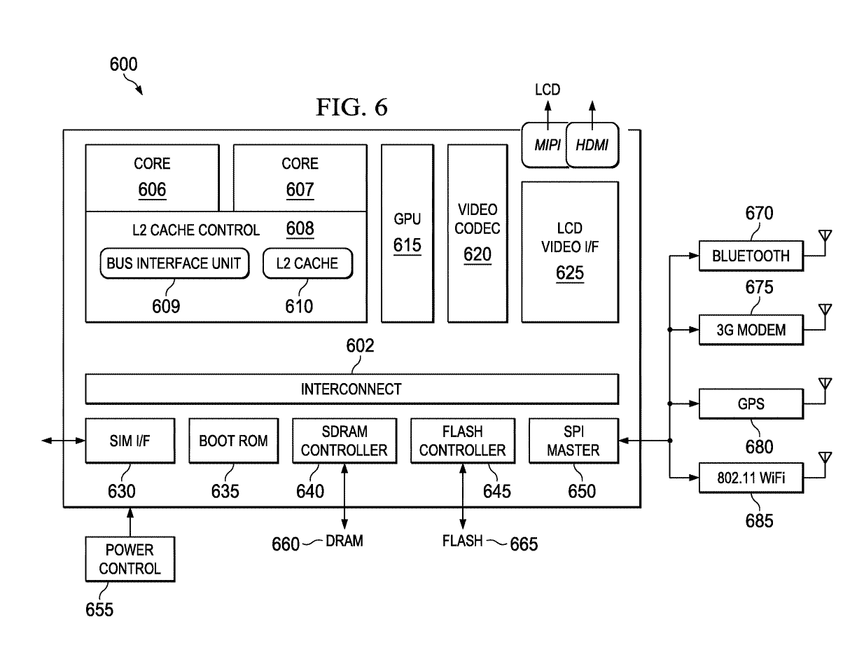

Turning to FIG. 6, FIG. 6 is a simplified block diagram associated with an example ARM ecosystem SOC 600 of the present disclosure. At least one example implementation of the present disclosure can include the single stylus features discussed herein and an ARM component. For example, the example of FIG. 6 can be associated with any ARM core (e.g., A-9, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 6, ARM ecosystem SOC 600 may include multiple cores 606-607, an L2 cache control 608, a bus interface unit 609, an L2 cache 610, a graphics processing unit (GPU) 615, an interconnect 602, a video codec 620, and a liquid crystal display (LCD) I/F 625, which may be associated with mobile industry processor interface (MIPI)/high-definition multimedia interface (HDMI) links that couple to an LCD.

ARM ecosystem SOC 600 may also include a subscriber identity module (SIM) I/F 630, a boot read-only memory (ROM) 635, a synchronous dynamic random access memory (SDRAM) controller 640, a flash controller 645, a serial peripheral interface (SPI) master 650, a suitable power control 655, a dynamic RAM (DRAM) 660, and flash 665. In addition, one or more example embodiments include one or more communication capabilities, interfaces, and features such as instances of Bluetooth™ 670, a 3G modem 675, a global positioning system (GPS) 680, and an 802.11 Wi-Fi 685.

In operation, the example of FIG. 6 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

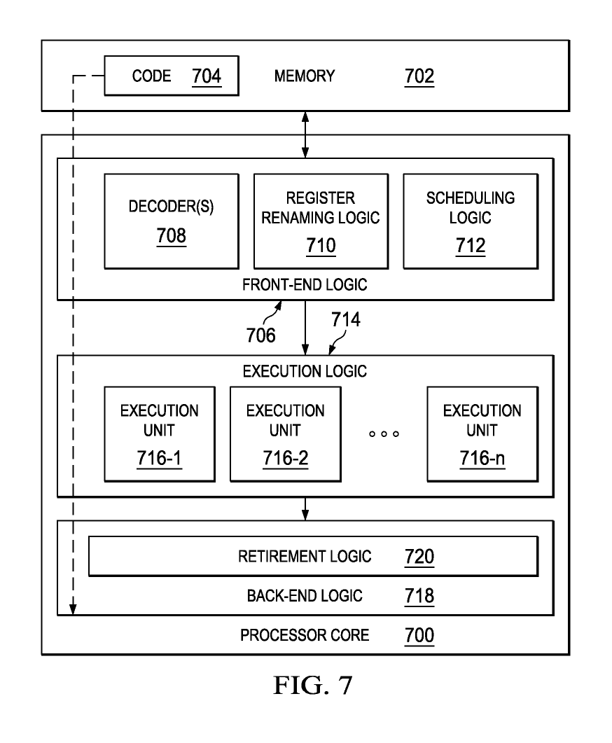

FIG. 7 illustrates a processor core 700 according to an embodiment.

Processor core 700 may be the core for any type of processor (e.g., processor 34), such as a micro-processor, an embedded processor, a digital signal processor (DSP), a network processor, or other device to execute code. Although only one processor core 700 is illustrated in FIG. 7, a processor may alternatively include more than one of the processor core 700 illustrated in FIG. 7. For example, processor core 700 represents one example embodiment of processors cores 574a, 574b, 574a, and 574b shown and described with reference to processors 570 and 580 of FIG. 5. Processor core 700 may be a single-threaded core or, for at least one embodiment, processor core 700 may be multithreaded in that it may include more than one hardware thread context (or “logical processor”) per core.

FIG. 7 also illustrates a memory 702 coupled to processor core 700 in accordance with an embodiment. Memory 702 may be any of a wide variety of memories (including various layers of memory hierarchy) as are known or otherwise available to those of skill in the art. Memory 702 may include code 704, which may be one or more instructions, to be executed by processor core 700. Processor core 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor core 700 can also include execution logic 714 having a set of execution units 716-1 through 716-N. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor core 700 allows out of order execution but requires in order retirement of instructions. Retirement logic 720 may take a variety of known forms (e.g., re-order buffers or the like). In this manner, processor core 700 is transformed during execution of code 704, at least in terms of the output generated by the decoder, hardware registers and tables utilized by register renaming logic 710, and any registers (not shown) modified by execution logic 714.

Although not illustrated in FIG. 7, a processor may include other elements on a chip with processor core 700, at least some of which were shown and described herein with reference to FIG. 6. For example, as shown in FIG. 6, a processor may include memory control logic along with processor core 700. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 10 and its teachings are readily scalable and can accommodate a large number of components, as well as more complicated/sophisticated arrangements and configurations. Accordingly, the examples provided should not limit the scope or inhibit the broad teachings of communication system 100 and as potentially applied to a myriad of other architectures.

It is also important to note that the operations described herein illustrate only some of the possible correlating scenarios and patterns that may be executed by, or within, electronic device 120. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by electronic device 120 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although electronic device 120 has been illustrated with reference to particular elements and operations that facilitate the communication process, these elements and operations may be replaced by any suitable architecture, protocols, and/or processes that achieve the intended functionality of electronic device 120.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example A1 is a device that includes a body, a plurality of conductive traces, a resonance circuit, and a tip, where the tip can be used to interact with both an electromagnetic resonance touchscreen and a capacitive touchscreen.

In Example A2, the subject matter of Example A1 may optionally include where conductive traces are spaced such that the conductive traces do not substantially block a resonance frequency of the resonance circuit.

In Example A3, the subject matter of any of the preceding ‘A’ Examples can optionally include where the conductive traces are in contact with the tip.

In Example A4, the subject matter of any of the preceding ‘A’ Examples can optionally include where the tip includes conductive rubber and the conductive traces include conductive material molded into the body.

In Example A5, the subject matter of any of the preceding ‘A’ Examples can optionally include where the conductive traces are imbedded on or in the surface of the body.

In Example A6, the subject matter of any of the preceding ‘A’ Examples can optionally include where the tip is replaceable.

In Example A7, the subject matter of any of the preceding ‘A’ Examples can optionally include where the device does not require any batteries.

Example M1 is a method that includes using a tip of a stylus for both an electromagnetic resonance touchscreen and a capacitive touchscreen. The stylus can include a body, a plurality of conductive traces, a resonance circuit, and the tip.

In Example M2, the subject matter of any of the preceding ‘M’ Examples can optionally include where conductive traces are spaced such that the conductive traces do not substantially block a resonance frequency of the resonance circuit.

In Example M3, the subject matter of any of the preceding ‘M’ Examples can optionally include where the conductive traces are in contact with the tip.

In Example M4, the subject matter of any of the preceding ‘M’ Examples can optionally include where the tip includes conductive rubber and the conductive traces include conductive material molded into the body.

In Example M5, the subject matter of any of the preceding ‘M’ Examples can optionally include where the conductive traces are imbedded on or in the surface of the body.

In Example M6, the subject matter of any of the preceding ‘M’ Examples can optionally include replacing the tip with a new tip.

In Example M7, the subject matter of any of the preceding ‘M’ Examples can optionally include where the stylus does not require any batteries.

An example system S1 can include a touchscreen, where the touchscreen can include an electromagnetic resonance touchscreen, a capacitive touchscreen, or both and a stylus. The stylus can include a body, a plurality of conductive traces, a resonance circuit, and a tip, wherein the tip can be used to interact with both the electromagnetic resonance touchscreen and the capacitive touchscreen.

In Example S2, the subject matter of any of the preceding ‘S’ Examples can optionally include where conductive traces are spaced such that the conductive traces do not substantially block a resonance frequency of the resonance circuit.

In Example S3, the subject matter of any of the preceding ‘S’ Examples can optionally include where the conductive traces are in contact with the tip.

In Example S4, the subject matter of any of the preceding ‘S’ Examples can optionally include where the tip includes conductive rubber and the conductive traces include conductive material molded into the body.

In Example S5, the subject matter of any of the preceding ‘S’ Examples can optionally include where the conductive traces are imbedded on or in the surface of the body.

In Example S6, the subject matter of any of the preceding ‘S’ Examples can optionally include where the tip is replaceable.

What is claimed is:

1. An device, comprising:
a body;
a plurality of conductive traces;
a resonance circuit; and
a tip, wherein the tip can be used to interact with both an electromagnetic resonance touchscreen and a capacitive touchscreen.

2. The electronic device of claim 1, wherein conductive traces are spaced such that the conductive traces do not substantially block a resonance frequency of the resonance circuit.

3. The electronic device of claim 1, wherein the conductive traces are in contact with the tip.

4. The electronic device of claim 3, wherein the tip includes conductive rubber and the conductive traces include conductive material molded into the body.

5. The electronic device of claim 1, wherein the conductive traces are imbedded on or in the surface of the body.

6. The electronic device of claim 1, wherein the device further comprises:
a battery, wherein the battery can be used to generate capacitance for use on capacitive touchscreen.

7. The electronic device of claim 1, wherein the device further comprises:
circuitry that can transmit a modulated signal to be coupled to the capacitive touchscreen.

8. A method, comprising:
using a tip of a stylus for both an electromagnetic resonance touchscreen and a capacitive touchscreen, wherein the stylus includes:
a body;
a plurality of conductive traces;
a resonance circuit; and
the tip.

9. The method of claim 8, wherein conductive traces are spaced such that the conductive traces do not substantially block a resonance frequency of the resonance circuit.

10. The method of claim 8, wherein the conductive traces are in contact with the tip.

11. The method of claim 8, wherein the tip includes conductive rubber and the conductive traces include conductive material molded into the body.

12. The method of claim 8, wherein the conductive traces are imbedded on or in the surface of the body.

13. The method of claim 8, further comprising:
replacing the tip with a new tip.

14. The method of claim 8, wherein stylus further includes:
a battery, wherein the battery can be used to generate capacitance for use on capacitive touchscreen; and
circuitry that can transmit a modulated signal to be coupled to the capacitive touchscreen.

15. A system, comprising:
a touchscreen, wherein the touchscreen can include an electromagnetic resonance touchscreen, a capacitive touchscreen, or both; and
a stylus, wherein the stylus includes:
a body;
a plurality of conductive traces;
a resonance circuit; and
a tip, wherein the tip can be used to interact with both the electromagnetic resonance touchscreen and the capacitive touchscreen.

16. The system of claim 15, wherein conductive traces are spaced such that the conductive traces do not substantially block a resonance frequency of the resonance circuit.

17. The system of claim 15, wherein the conductive traces are in contact with the tip.

18. The system of claim 15, wherein the tip includes conductive rubber and the conductive traces include conductive material molded into the body.

19. The system of claim 15, wherein the conductive traces are imbedded on or in the surface of the body.

20. The system of claim 15, wherein the tip is replaceable.
